(19) United States
(12) Patent Application Publication
(10) Pub. No.: US 2006/0037561 A1
(43) Pub. Date: Feb. 23, 2006

(54) Animal boot

(76) Inventor: Amy C. Fine, New York, NY (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 11/206,514

(22) Filed: Aug. 17, 2005

Related U.S. Application Data
(60) Provisional application No. 60/602,382, filed on Aug. 18, 2004.

(51) Int. Cl. A01K 13/00

(52) U.S. Cl. 119/850

(57) ABSTRACT

An animal boot that includes a tubular shaped flexible material having an inside diameter and a length adapted to receive an animal foot and at least a portion of an animal leg. The tubular shaped flexible material includes an open upper end; a toe box; and an elongated hollow middle portion connecting the open upper end to the toe box. At least a portion of the toe box is reinforced.

### CROSS REFERENCE TO RELATED APPLICATIONS

This application claims the benefit of U.S. provisional application Ser. No. 60/602,382 entitled “Pet Boot” which was filed on Aug. 18, 2004, the entirety of which is incorporated by reference herein.

### BACKGROUND OF THE INVENTION

(1) Field of the Invention

This invention relates to footgear for animals. More particularly, this invention relates to form-fitting animal boots or socks.

(2) Description of the Related Art

Animal owners have made many attempts to protect animal's legs and paws from debris, weather, and other harmful elements. In the winter, many animal owners want to protect their animals from ice, snow, salt and other wintry conditions. Likewise, in the summer months, hot pavement, gravel and sand provide discomfort to an animal's foot or paws and lower legs. Additionally, there is always a risk of exposing the animal's paw pads and lower legs to sharp debris such as rocks, glass or metal, and other potential hazards such as toxic liquids and other toxic or harmful material. Many boots, booties, or other footgear have been developed to provide protection against these hazards. Additionally, animal owners have also looked to footgear as novelty fashion items, walking aids, and for protection from cold and/or wet weather.

The prior art discloses a leather dog boot that is designed to keep the rear foot of a dog warm as well as clean to prevent soiling of the household and its contents. Also shown in the prior art is a dog boot that includes a planar flexible sheet of material having a high friction surface on one side thereof. Generally, this boot is for use on dog paws or feet to overcome certain inabilities of an individual animal and to facilitate walking or other ambulatory action for the animal over slippery floors or surfaces.

Additionally, the prior art illustrates a paw covering which consists essentially of a condom-like sleeve formed of rubber latex. This paw covering has a larger cross section in the form of a bead around the open end for easy application and removal of the condom-like device from the paw.

While a variety of animal footgear exists to protect, assist, or accessorize an animal, many of the footgear require unnecessary and uncomfortable attachments such as straps, bands and laces that interfere with an animal's ability to properly use the footgear. These attachments cause frustration to the animal by irritating its skin and/or fur, and also cause frustration to the animal's owner when their animal is gnawing, biting, or otherwise attempting to free itself from the footgear. Additionally, many of the footgear that exists is made out of expensive material. While expensive material is needed for some animals, such as hunting dogs that are exposed to rough terrain and potentially harsh weather conditions, many animal owners may not wish to purchase expensive footgear because the animal may destroy or not wear the footgear. Additionally, this expensive material usually requires cleaning and maintenance by the pet owner.

While inexpensive and easy to use pet foot gear is important to many animal owners owning common household pets, such footgear may have useful applications in the veterinary field, the guide dog field, for use with search and rescue animals and professional show dogs.

### BRIEF SUMMARY OF THE INVENTION

One aspect of the invention relates to an animal boot. The animal boot includes a tubular shaped flexible material having an inside diameter and a length adapted to receive an animal foot and at least a portion of an animal leg. The tubular shaped flexible material has an open upper end; a toe box; and a hollow elongated middle portion connecting the open upper end to the toe box, wherein at least a portion of the toe box is reinforced.

Another aspect of the present invention relates to a method for adjusting an animal boot on an animal. The method includes the steps of: gathering the animal boot and placing the animal boot onto an animal foot; aligning an end portion of a toe box of the animal boot with a front portion of the animal foot; pulling an open upper end of the animal boot to a height on a leg of the animal; and optionally altering excess material of the animal boot to adjust the animal boot.

Yet another aspect of the present invention relates to a method of manufacturing an animal boot. The method includes the steps of: selecting a flexible material that comprises at least one characteristic selected from: chemical resistance, ozone degradation resistance, ultraviolet light degradation resistance, insulation from electricity, tear resistance, and combinations thereof; and forming the flexible material into a tubular shaped piece, the tubular shaped piece comprising: an open upper end; a toe box; an elongated hollow middle portion connecting the open upper end to the toe box; and reinforcing the toe box of the flexible material to accommodate a foot of an animal.

### BRIEF DESCRIPTION OF THE DRAWINGS

For the purpose of illustrating the invention, the drawings show a form of the invention that is presently preferred. However, it should be understood that the present invention is not limited to the precise arrangements and instrumentalities shown in the drawings, wherein:

FIG. 1 is a side view of a rear animal leg wearing the animal boot of the present invention.

FIG. 1a is a side view of a rear animal leg wearing the animal boot of the present invention. The animal boot includes ribbing.

FIG. 2 is a side view of a front animal leg wearing the animal boot of the present invention.

FIG. 2A is a side view of a front animal leg wearing the animal boot of the present invention. The animal boot includes ribbing.

FIG. 3 is a top view of a rear animal leg wearing the animal boot of the present invention.

FIG. 3A is a bottom view of a rear animal leg wearing the animal boot of the present invention.

FIG. 4 is a top view of a rear leg of an animal wearing the animal boot having ribbing.

FIG. 4a is a bottom view of a rear leg of an animal wearing the animal boot having ribbing.

FIG. 5 is a top view of a front leg of an animal wearing the animal boot of the present invention.

FIG. 5a is a bottom view of a front leg of an animal wearing the animal boot of the present invention.

FIG. 6 is a top view of a front leg of an animal wearing the animal boot having ribbing.

FIG. 6a is a bottom view of a front leg of an animal wearing the animal boot having ribbing.

### DETAILED DESCRIPTION

An animal boot of the present invention is made of a tubular shaped flexible material that is adapted to receive an animal foot or paw (hereinafter referred collectively as “foot”) and at least a portion of an animal leg. It is contemplated that any legged animal may wear this animal boot. However, the animal boots are particularly useful for domesticated animals such as dogs and cats who often walk inside and outside of a house or other building. The animal boots may also be used on other animals, including horses and livestock. Additionally, it is contemplated that the boot of the present invention may be altered to fit a human's limb or at least a portion of a human's limb. Such a covering could be useful in the human medical field to cover casts, or provide protection to other injuries.

At one end, the tubular shaped flexible material has an open upper end. At the opposing end, the tubular flexible material has a toe box. The open upper end is connected to the toe box by an elongated hollow middle portion.

The flexible material is preferably a material that can easily be placed onto and taken off an animal's foot and leg. The flexible material may compress an animal's foot and at least a portion of an animal's leg to form a firm fit around the paw and portion of the leg. To provide additional comfort to the animal wearing the animal boot, the flexible material should not rip, tear or snag at an animal's fur or skin.

Flexible material that can be used to form the animal boot includes, but is not limited to, any rubber-based material. Latex, plastic, vinyl, nitrile or butadyl may be used as the flexible material which forms the animal boot. The term “nitrile” is meant to include polyacrylonitrile as well as rubber nitrile and acrylonitrile. Other materials that may be used include KEVLAR®, which is manufactured by DuPont Co. The flexible material may include spandex or LYCRA®, a stretchable fiber for use in fabric or other material. LYCRA® is registered to Invista North America.

In addition to being flexible and form-fitting, the flexible material of the animal boot may include other characteristics as well. Those characteristics include, but are not limited to: chemical resistance, insulation from electricity, sun degradation resistance (specifically ultra violet (UV) light resistance), ozone degradation resistance, all-weather capability (i.e. the ability to withstand varying temperatures as well as varying amounts of moisture), and combinations of such characteristics. As one skilled in the art will appreciate, selection of a particular flexible material will provide certain characteristics for the animal boot. Accordingly, the material selected for the animal boot will depend on the characteristics that are desired to be exhibited by the animal boot. It is contemplated that the flexible material of the animal boot will have more than one of the above-noted characteristics.

Regardless of the particular material used to form the animal boot, the flexible material should be flexible enough to easily be gathered and placed on a foot and at least a portion of a leg of an animal by inserting the foot into the open upper end of the animal boot, aligning an end portion of the toe box with a front portion of the foot of the animal, and pulling the open upper end of the animal boot to a desired height on the leg of the animal. Gathering and placing the animal boot onto an animal's foot is similar to how a woman gathers pantyhose into a compact form and places the pantyhose onto her foot. The animal boot of the present invention can be used on both the front and hind feet and legs of an animal.

Although flexibility and elasticity are the primary characteristics of the flexible material, the flexible material must be durable as well. The flexible material of the animal boot should resist tears, rips or punctures that may be caused by normal use of the animal boot. Additionally, the elasticity, flexibility and ribbing that may be present on the animal boot will allow the flexible material to retain its shape after use.

Additionally, it is contemplated that the flexible material used to manufacture the animal boot may be inexpensive enough to justify disposal of the animal boot after just one use. This would allow for the easiest maintenance for the animal owner—none. However, it is also contemplated that the flexible material can withstand several or many uses.

The animal boots of the present invention may be packaged individually or sold in packages of multiple boots (“multi-packs”). Such multi-packs are contemplated for animal boots that can be thrown out after only one use.

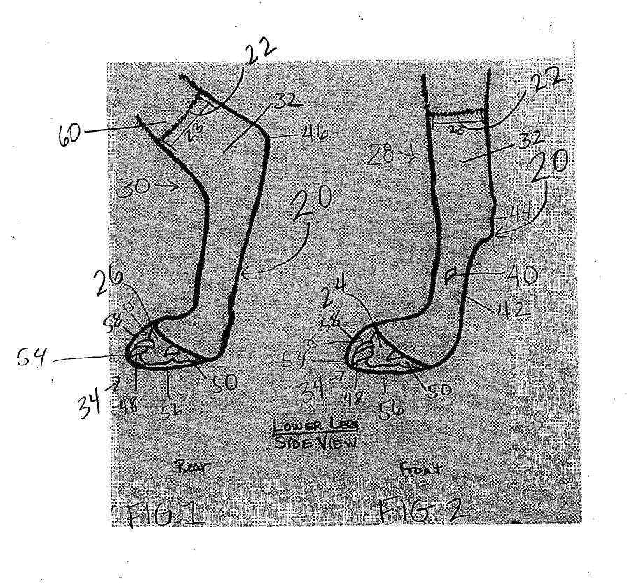

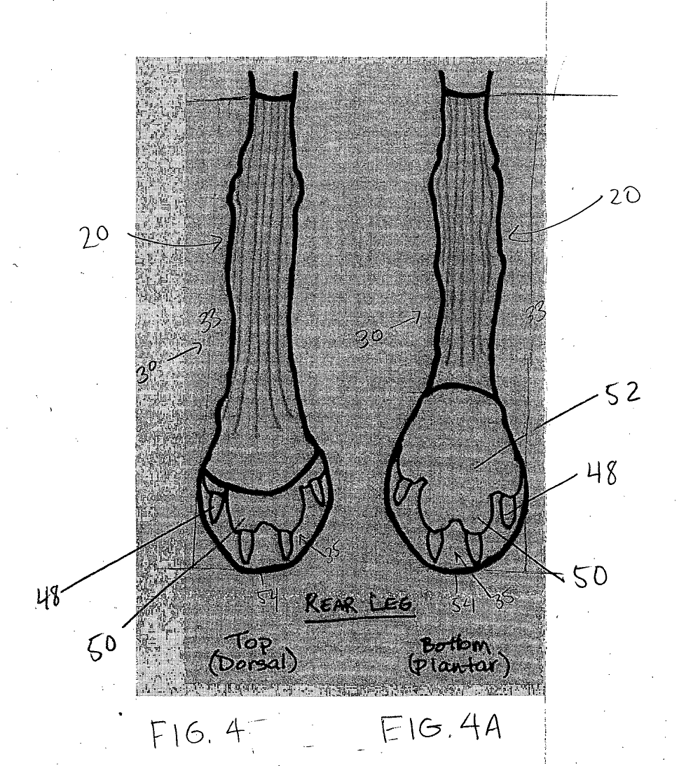

Referring now to FIGS. 1-6a, a pet boot 20 is shown on the front and rear foot and leg of a dog. While the figures illustrate the use of animal boot 20 on a dog, the animal boot may also be used on other animals such as cats, ferrets, horses, pigs, and the like.

Pet boot 20 is made of a piece of tubular flexible material that includes open upper end 22. Open upper end 22 allows a forefoot 24 or a hind foot 26 and at least a portion of a front leg 28 or a hind leg 30 to be inserted into pet boot 20. To provide additional comfort and flexibility, open upper end 22 is usually not beaded.

Open upper end 22 has an inside diameter 23 which can expand to adapt to different size animal legs. Animal boot 20 may be manufactured with inside diameter 23 ranging between about 0.5 inch and about 6 inches.

The flexible material of animal boot 20 has a length 33 which can vary depending on the needs of a particular user. Length 33 can range from about 0.5 inches to about 20 inches.

The flexible material of animal boot 20 also includes an elongated hollow portion 32 which connects open upper end 22 to a toe box 34. As shown in FIGS. 1a, 2a, 4, 4a, 6, and 6a, elongated hollow portion 32 is ribbed, indicated by ribbing lines 36. Ribbing 36 allows animal boot 20 to adapt to a variety of sizes of animal front and hind feet and legs. Ribbing 36 may extend lengthwise along elongated hollow portion 32 from open upper end 22 to toe box 34. However, as shown clearly in FIG. 1a, ribbing 36 extends from open upper end 22 to a point 38. When ribbing 36 extends to point 38, the remainder of flexible material that extends to toe box 34 does not contain ribbing 36. While the enclosed figures illustrate ribbing 36 extending lengthwise (i.e. parallel to the animal's leg) along elongated hollow portion 32, it is contemplated that ribbing 36 may extend in a circumferential manner about elongated hollow portion 32, or in a spiral manner about elongated hollow portion 32. Additionally, although not shown in the enclosed figures, it is contemplated that ribbing 36 may also extend in a manner that is transverse to the animal's leg.

In addition to providing adaptability to different size animal legs, ribbing 36 provides an amount of compression necessary to allow animal boot 20 to remain in a form-fitting position on front leg 28 or hind leg 30. Ribbing 36 permits animal boot 20 to compress front leg 28, hind leg 30, forefoot 24 or hind foot 26 from all sides and all surfaces.

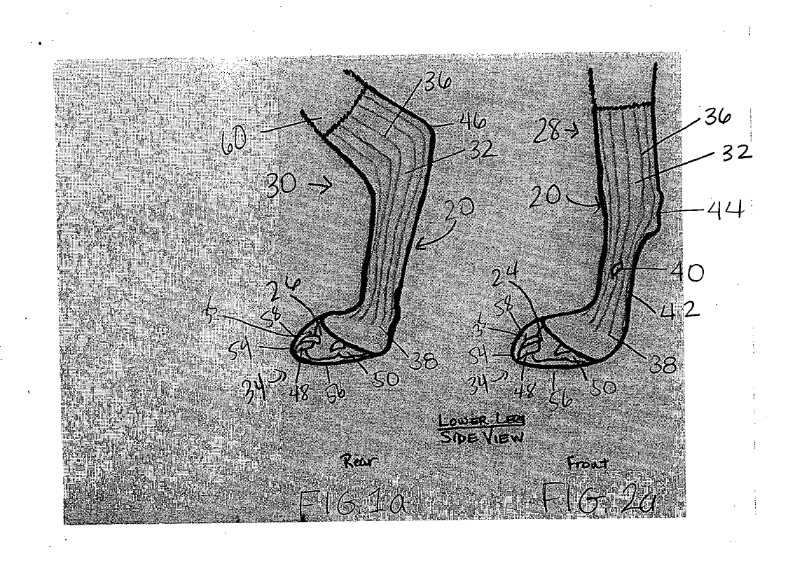

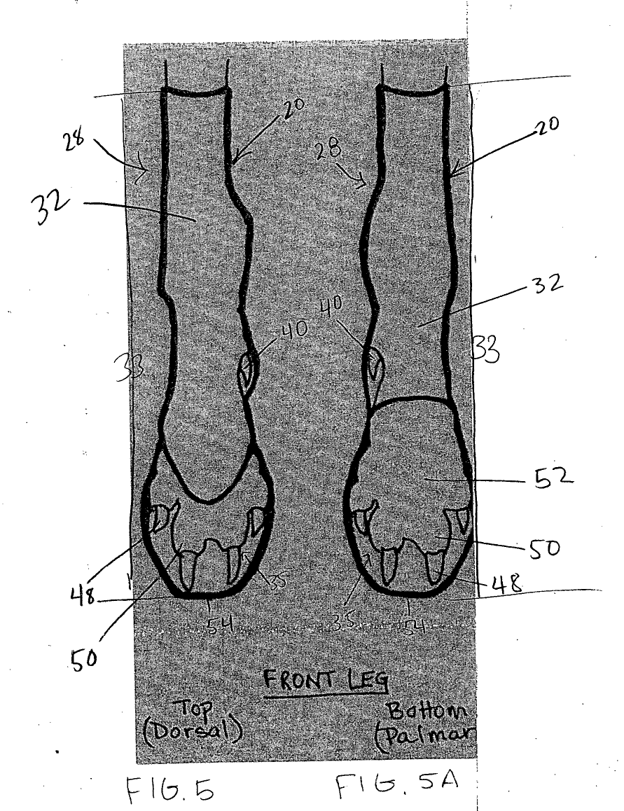

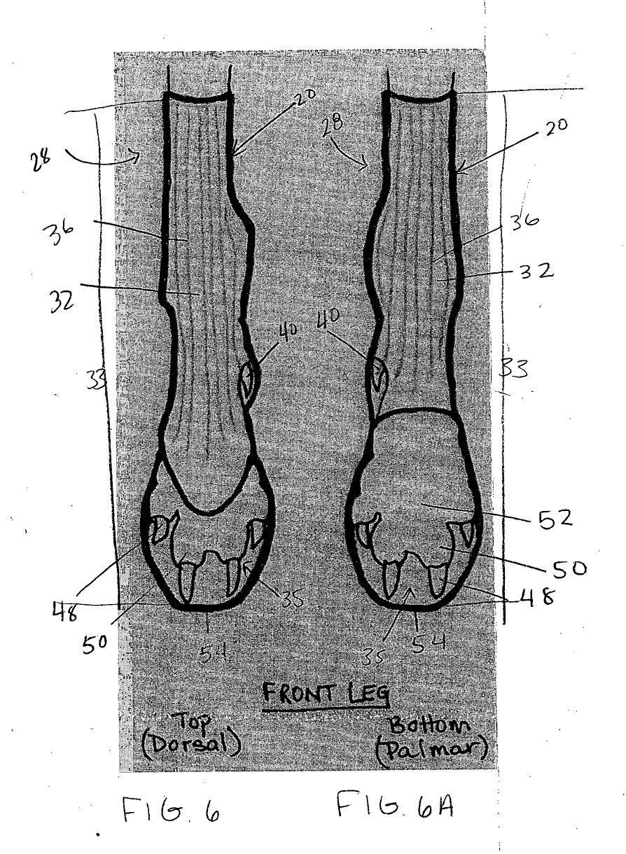

Similar to open upper end 22, elongated hollow portion 32 is made of a flexible material that is adapted to fit over any roughness or deformity a particular animal may have in its forefoot 24, hind foot 26, front leg 28 or hind leg 30. As shown best in FIGS. 5-6a, many animals have a dew claw 40 which, on dogs, is located above pastern 42. Elongated hollow portion 32 is also adapted to fit over anatomical parts of an animal's leg such as a wrist 44 shown in FIG. 2, and a hock 46 shown in FIG. 1.

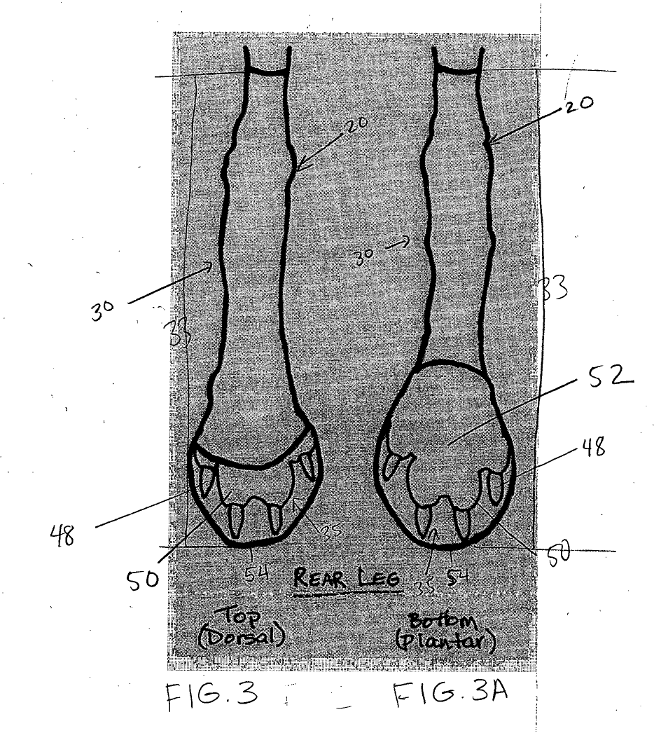

Connected to the end of elongated hollow portion 32, opposite open upper end 22, is toe box 34. Toe box 34 refers to the portion of animal boot 20 that encompasses a front portion 35 of an animal foot that includes claws 48, toes 50 and at least one pad 52 present on the bottom of forefoot 24 or hind foot 26. As one of ordinary skill in the art will appreciate, not all animals have claws 48, toes 50 and pad 52. A top view of toe box 34 is clearly illustrated in FIGS. 3, 4, 5 and 6. Here, claws 48 and toes 50 are shown to be contained in toe box 34. Specifically, FIGS. 3, 4, 5 and 6 illustrate that an end portion 54 of toe box 34 is aligned with a front portion 35 of the animal's foot; specifically it is aligned with at least one claw 48. Although not illustrated in the accompanying Figures, if an animal does not have at least one claw 48, the end portion 54 of toe box 34 will be aligned with at least one toe 50, or the end of the animal's foot or paw.

Toe box 34 is made of the same flexible material elongated hollow portion 32 and open upper end 22 are made of. To provide pad 52, toes 50 and claws 48 additional protection from outdoor elements, a bottom portion 56 of toe box 34 may be reinforced. By reinforced it is meant that additional layers of the same flexible material are added to at least a portion of toe box 34. Alternatively, additional layers of other materials or fabrics can be added to at least a portion of toe box 34 to provide such reinforcement. In addition to reinforcing bottom portion 56 of toe box 34, a top portion 58 of toe box 34 may also be reinforced.

Reinforcement of at least a portion of toe box 34 prevents or inhibits claws 48 from ripping, tearing or breaking through the flexible material. While one layer of flexible material may provide this tear resistance, many animal owners may want additional reinforcement to protect the animal's foot from debris. The reinforcement also provides durability to the part of animal boot 20 that receives the most wear and tear.

Additionally, at least a portion of toe box 34 can include cushioning. Such cushioning can be provided by inserting a pocket of air or gel, or any other material that would provide additional protection of an animals paw or foot from debris.

At least a portion of toe box 34 may be textured. Such texture may be added to toe box 34 with or without reinforcement of toe box 34. The addition of texture provides animal boot 20 with traction when used on slippery surfaces. The texture can be simple cross hatches, raised pieces of the same flexible material used to make animal boot 20, or a design that is raised slightly higher from the surface of a portion of toe box 34. The texture is typically placed on bottom portion 56 of toe box 34.

Referring more particularly now to FIGS. 1-2a, animal boot 20 is shown as being form fitting to hind leg 30 and front leg 28. This fit allows the animal to move around comfortably with animal boot 20 in place. Additionally, ribbing 36 allows animal boot 20 to stay in place while the animal moves about. Ideally, the flexible material of animal boot 20 present in open upper end 22, elongated hollow portion 32, and toe box 34 is thin enough to allow the animal to feel the surface that is present beneath its forefoot 24 and hind foot 26 as well as allow the animal to feel any object that may come into contact with its hind leg 30 or front leg 28 while it is wearing animal boot 20. The flexible material of animal boot 20 may have a thickness between about 0.0001 inch and about 0.5 inch (between about 0.1 mil and about 500 mils). In another example, the material of the animal boot has a thickness between about 0.001 inch and about 0.4 inch (between about 1 mils and about 400 mils). In another example, the flexible material has a thickness between about 0.001 inch and about 0.2 inch (between about 1 mils and 200 mils). The thickness of the flexible material may be uniform from open upper end 22 to end portion 54 of toe box 34, or the thickness may increase in the portions of toe box 34 that are reinforced.

While FIGS. 1-2a show animal boot 20 extending from a stifle portion 60 of front leg 28 and rear leg 30, it is contemplated that open upper end 22 of animal boot 20 can be placed at a lower or higher part of front leg 28 or hind leg 30. The placement of open upper end 22 will depend on the animal's preference. Once a preferred height on front leg 28 or hind leg 30 for placement of upper open end 22 is found, the animal's owner can alter animal boot 20 by removing a portion of animal boot 20 that extends beyond the preferred height on front leg 28 or hind leg 30. To do so, animal boot 20 is placed on the animal's front leg 28 or hind leg 30, the end portion 54 of toe box 34 is aligned with front portion 35 of the animal's foot, the flexible material of elongated hollow middle portion 32 is pulled taught up the length of front leg 28 or hind leg 30, the preferred height is then marked in pen or marker on animal boot 20 by the animal's owner. Animal boot 20 may be removed from the animal and cut or trimmed at the preferred height to adjust the length. The animal owner is encouraged to experiment with the length of the animal boot. Additionally, the animal owner should praise and reward the animal, using positive reinforcement, for wearing the pet boot, even if only worn for a short time.

As will be appreciated by one of ordinary skill in the art, the animal boot of the present invention may be any color, and may have designs incorporated into or attached on to the flexible material.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

What is claimed is:

1. An animal boot comprising:
a tubular shaped flexible material having an inside diameter and a length adapted to receive an animal foot and at least a portion of an animal leg, the tubular shaped flexible material comprising:
an open upper end;
a toe box; and
an elongated hollow middle portion connecting the open upper end to the toe box, wherein at least a portion of the toe box is reinforced.

2. An animal boot according to claim 1 wherein said tubular flexible material has ribbing extending about said elongated hollow middle portion.

3. An animal boot according to claim 2 wherein said ribbing extends about said elongated hollow middle portion in at least one manner selected from: parallel to said animal leg, transverse to said animal leg, circumferentially about said animal leg, spirally about said animal leg, and combinations thereof.

4. An animal boot according to claim 2 wherein at least a portion of said toe box is cushioned.

5. An animal boot according to claim 2 wherein said tubular shaped flexible material is selected from: rubber, latex, butadyl, nitrile, vinyl, neoprene, plastic, spandex and combinations thereof.

6. An animal boot according to claim 5 wherein said tubular shaped flexible material is nitrile.

7. An animal boot according to claim 1, wherein said inside diameter is between about 0.5 inch and about 6 inches.

8. An animal boot according to claim 1 wherein said length is between 0.5 and 20 inches.

9. An animal boot according to claim 1, wherein at least a portion of said toe box comprises texture.

10. An animal boot according to claim 1, wherein said flexible material has a thickness between about 0.0001 inch and about 0.5 inch.

11. A method for adjusting an animal boot on an animal, comprising the steps of:
gathering the animal boot and placing said animal boot onto an animal foot;
aligning an end portion of a toe box of the animal boot with a front portion of the animal foot;
pulling an open upper end of the animal boot to a height on a leg of the animal; and
optionally altering excess material of the animal boot to adjust the animal boot on the animal.

12. A method according to claim 11 wherein the optionally altering step comprises the step of cutting the excess material present on the animal boot.

13. A method of manufacturing an animal boot comprising the steps of:
selecting a flexible material that comprises at least one characteristic selected from: chemical resistance, ozone degradation resistance, ultraviolet light degradation resistance, insulation from electricity, tear resistance, and combinations thereof; and
forming the flexible material into a tubular shaped piece, the tubular shaped piece comprising:
an open upper end;
a toe box;
an elongated hollow middle portion connecting the open upper end to the toe box; and
reinforcing the toe box of the flexible material to accommodate a foot of an animal.

14. A method according to claim 13 wherein said flexible material is selected from: rubber, latex, neoprene, butadyl, nitrile, and combinations thereof.

15. A method according to claim 13 comprising:
adding texture to at least a portion of the toe box.

16. A method according to claim 13 comprising:
adding ribbing to at least a portion of the elongated hollow middle portion.

17. A method according to claim 13 comprising:
adding cushioning to at least a portion of the toe box.

18. A method of claim 13 wherein the animal boot has a length of between about 0.5 inch to about 6.0 inch.

19. A method of claim 13 wherein the open upper end has an inside diameter between about 0.5 inch and about 6 inches.

20. A method of claim 13 wherein the flexible material has a thickness between about 0.0001 inch and about 0.5 inch.
